(19) United States
(12) Patent Application Publication
(10) Pub. No.: US 2026/0324589 A1
(43) Pub. Date: Oct. 22, 2026

(54) Controllable Feeder

(71) Applicant: All Seasons Feeders, Ltd., San Antonio, TX (US)

(72) Inventor: William Zachary Gates, San Antonio, TX (US)

(21) Appl. No.: 19/568,086

(22) Filed: Mar. 16, 2026

Related U.S. Application Data
(60) Provisional application No. 63/773,505, filed on Mar. 18, 2025.

(51) Int. Cl. A01K 11/00

(52) U.S. Cl. CPC A01K 11/006

(57) ABSTRACT

A controllable hopper is disclosed. The controllable hopper has a controllable feed cover which can move from an open position to a closed position. A controllable hopper has a hopper housing, a controllable feed cover moveable relative to a trough. The feed cover moves from an open position whereby feed is accessible to a closed position whereby feed is inaccessible. The feed cover is in communication with a controller. The controller is in communication with a camera. The system and method allow access to the feed for intended species. The system and method prevents access for unintended species.

### BACKGROUND OF THE INVENTION

### Priority

The present invention claims priority to U.S. Provisional Application No. 63/773,505 filed Mar. 18, 2025, the entirety of which is hereby incorporated by reference.

### Technical Field

The present invention relates to a system and method for a controllable feeder.

### Description of Related Art

Feeders are used to automatically feed domestic and wild animals. However, often there is a need for increased control. Consequently, there is a need for a feeder which offers increased control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a controllable feeder system in one embodiment;

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

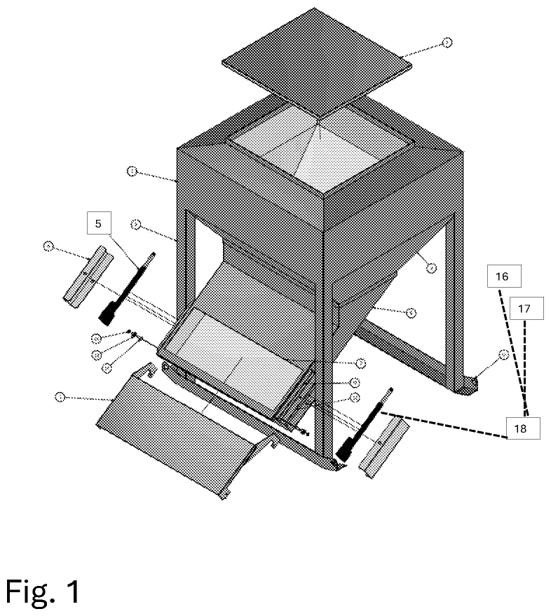

FIG. 1 is a perspective view of a controllable feeder system in one embodiment. A controllable feeder, as used herein, is a feeder whereby the feeder cover 2 can be opened and closed as desired to control access to the feed therein.

The controllable feeder can include feeders for domestic or wild animals. The feeder can be controlled and powered by virtually any means, including but not limited to, solar, battery, electricity from the grid, etc.

One particular type of controllable feeder is discussed in reference to FIG. 1. However, this discussion is for illustrative purposes only and should not be deemed limiting. The features and concepts can be applied to a variety of feeders and are not limited to the specific feeder discussed herein.

The controllable feeder can comprise a gravity feeder, a spinner feeder, etc. Virtually any type of feeder which deploys feed for animal consumption can be utilized.

Users of a feeder often have a specific type of species to which the feeder is directed. If the feeder is a deer feeder, as an example, the user desires to feed deer. The deer is the intended species as this is the type of species the user intends to feed. The user spends funds and time to ensure the desired/intended species is fed. Accordingly, feed which goes to other unintended species, such as racoons, cattle, etc., wastes the time and money of the user. Feed going to an unintended species frustrates the purpose behind the feeder. An unintended species is a species that the user does not intend to feed. If the user intends to feed deer, deer is the intended species whereas a racoon is an unintended species.

Accordingly, in one embodiment, the controllable feeder has a moveable feed cover 2 to assist in limiting deployment of the feed to the intended, rather than the unintended, species. As will be discussed, the moveable feed cover 2 can open or close as desired to encourage or discourage a species from feeding at the feeder.

The feed cover 2 can be moved or controlled via any mechanism known in the art. These can include pistons, springs, etc. In the embodiment depicted, the feed cover 2 is coupled to actuators 5 on each side of the feed cover 2. The actuators 5 can be activated to move the feed cover 2 from an open position whereby food is accessible, to a closed position whereby food is inaccessible.

Turning to the top of FIG. 1, the feeder has a hopper lid 1. The hopper lid 1, in one embodiment, is removable. This allows the hopper housing 3 to be filled and refilled with feed as desired. The hopper lid 1 also keeps moisture and rain out of the hopper housing 3.

The hopper housing 3 holds the feed. The feed can comprise virtually any type of feed which is deployed to animals. This can include deer feed, seeds, etc.

The volume within the hopper housing 3 can vary depending upon the desired application. The larger the volume, the less frequently the user must refill the hopper housing 3. In one embodiment the hopper housing 3 comprises sensors (not shown) so that the user can monitor the level within the hopper housing 3. The hopper sensors can be located at the hopper top, at the hopper bottom, or along the hopper walls. Virtually any type of sensor which can determine the level within the hopper can be utilized. As will be discussed, in one embodiment the feeder is in communication, remotely, with the user. In such embodiments, a remote user can ascertain and monitor the level within the hopper housing 3. This capability notifies the user when additional feed is necessary. Often a user will have more than one feeder. Thus, the ability to remotely monitor the level of a plurality of feeders allows the user to know which, if any, feeders need additional feed.

As shown, the feeder utilizes a hopper funnel 4. The hopper funnel 4 employs gravity to funnel the feed to the desired location. In this case, the desired location is the front side of the funnel and the feed trough 7, located on the front face of the feed.

Coupled to, and below the hopper funnel 4, is the angled disbursement 8. This is an angled panel which directs feed received from the hopper funnel 4 forward to the below open feed trough 7. The length of the angled disbursement 8 can be adjusted depending upon the desired location of the feed trough 7.

The feed trough 7 is an open area through which feed can be retrieved from the desired animal. The feed trough 7 can simply be open to allow the animal access to the contents, or the feed trough 7 can comprise a spinner plate or other mechanism to actively disperse the feed.

As noted the feed cover 2 can be manipulated by a variety of devices, including an actuator 5. As shown, there is a recess for an actuator housing 12 which supports and covers the actuator 5. This ensures the actuator 5 is protected from damage. The system, as depicted, also utilizes baffles 11 for increased structural support. An actuator 6 cover can be removed to provide access to the actuator 5.

As noted, while an actuator 5 has been described, this is for illustrative purposes only. Virtually any mechanism which allows the cover to be moved or rotated can be utilized.

In one embodiment, as shown, the feed cover 2 moves laterally relative to the feed trough 7. This can be accomplished via the actuators 5, or other devices. In other embodiments, however, the feed cover 2 moves angularly relative to the feed trough 7. In one such embodiment, the feed cover 2 will pivot from an open to a closed position. As but one example, the feed cover 2 comprises a hinge which allows the feed cover 2 to rotate from an open to a closed position.

The feed cover 2 can be coupled to the actuators 5 via any means known in the art. Thus, movement and placement of the feed cover 2 can be controlled by moving/advancing the actuators 5.

In one embodiment the system comprises one or a plurality of wheels upon which the sliding feed cover 2 can move. Wheels reduce friction between the cover 2 and the hopper. Accordingly, the wheels can also reduce noise when the cover 2 is opening or closing. As shown, the tray cover wheels 13 are supported by a roller bolt 14 and roller nuts 15.

As shown the hopper housing 3 is supported by a plurality of support legs 9. As depicted there are four support legs 9, but this is for illustrative purposes and should not be deemed limiting. The support legs 9 offer support to the hopper. The support legs 9 also elevate the hopper housing 3 relative to the ground.

The support legs 9 can couple to the ground via virtually any mechanism known in the art. As shown the support legs 9 comprise feeder skid 10. The feeder skid 10 can allow grasping the feeder for movement and placement. The feeder skid 10 can have wheels or other tools to allow for easier movement and placement.

In one embodiment the hopper, and in particular the cover 2, is controlled by a controller 18. The controller 18 can comprise any controller known in the art. The controller 18 can receive and distribute commands. The controller 18 can be stored locally, on or near the feeder, or the controller 18 can be stored and housed remotely. The controller 18 can receive commands from a remote controller, such as computer, smart phone, timer, etc.

As depicted, the controller 18 is coupled to a sensor 16 and a camera 17. The camera 17 can comprise virtually any camera 17 known in the art. While one camera 17 is shown, this is for illustrative purposes only. In some embodiments, more than one camera 17 can be utilized.

In one embodiment, one purpose of the camera 17 is to identify the animal type which is in close proximity to the feeder. As such, in one embodiment the camera 17 comprises a species identifying camera. A species identifying camera can comprise any camera that can independently, or with external sources, identify a species. A species identifying camera can comprise a traditional game camera, for example, that coordinates with local or remote technology that can use images or video from the camera and identify the species. The technology can be located on the camera, or it can be located remotely. Thus, the camera 17 can coordinate with remote software, as an example, to determine the species captured by the camera. The camera 17, in this fashion, can identify both intended and unintended species. In one example, if the camera 17 detects an unintended species, the camera 17 can provide this information to the controller 18. In some embodiments, the controller 18 will then direct the feed cover 2 to close to prevent access by the unintended species.

If the feed cover 2 is the in closed position, and the camera 17 detects an intended species, the camera 17 can inform the controller 18. Depending upon the parameters, the controller 18 may instruct the feed cover 2 to open to allow access to the intended species. The controller 18 can have a variety of parameters. These can include, but are not limited to, time, weather conditions, detected animals, and others. Thus, even if an intended species is detected, the controller 18 may override and follow the timer instead. Further, even if there is an intended species detected, information concerning weather can override. Thus, even if an intended species is detected, the controller 18 can still dictate that the feed cover 2 is closed. The controller 18 can weigh different demands and logic to determine if the cover 2 should be in the opened position, whereby feed is accessible, or closed position whereby feed is inaccessible.

In still other embodiments, the feeder remains open until an unintended species is detected. At that point, the cover closes.

Consider a deer feeder which is designed to feed deer. If the feed cover 2 is in the open position, whereby feed is accessible, and a deer is detected by the camera 17, the controller 18 can instruct the feed cover to remain open. If a deer is nearby, and the feed cover 2 is in the closed position, whereby feed is inaccessible, the controller 18 can instruct the feed cover 2 to open. As noted, time restrictions can also apply so even if the camera 17 detects a deer, if the time restrictions mandate the feed cover 2 be closed, then it can remain closed.

Conversely, if the feed cover 2 is open, and an unintended species, such as a racoon, is detected by the camera 17, the controller 18 can instruct the feed cover 2 to close. This prevents access to the feed by the racoon. After the racoon has left, the feed cover 2 can open again.

As can be seen, the camera 17 and the controller 18 provide increased control and flexibility to the system. The feeder can be moved from accessible to inaccessible, and vice versa, depending upon the animal detected. As such, in one embodiment, the camera 17 and/or the controller 18 are coupled to software to determine animal species based on input from the camera 17. The software can be stored and executed at the controller, or the software can be stored and executed remotely. The software can utilize any shape determining capability. The software can store images of known species, and compare images captured by the camera to species-known images. In this manner, the software can determine the image of the animal captured by the camera. Based on the configuration of the controller, the result can inform the controller if the cover 2 should be opened or closed.

The camera 17, in some embodiments, is motion activated. Thus, the camera is not saving or taking images unless motion is detected. The camera can include video, static images, black and white, infrared, etc. Virtually any type of camera used for trail cameras, for example, can be utilized.

In some embodiments the camera 17 also saves the images. The images can be saved locally on a storage device (such as a flash drive, hard drive, etc.), or the images can be sent remotely. As an example, the camera 17 and/or the controller 18 and/or the feeder, can be coupled via wire or wirelessly to a communication system. In such embodiments images can be sent to a user. Accordingly, the camera 17 can act and function as a game camera. However, the camera 17 has the added benefit, in some embodiments, of 1) identifying animal species, and 2) providing such information to a controller to control operation of a feeder.

In some embodiments, the system further includes a sensor 16. In one embodiment the sensor 16 is a rain or moisture sensor. Consider a rain sensor 16. If the feed cover 2 is open and there is a hard rain, the rain sensor 16 can communicate such to the controller 18. The controller 18 can then communicate and close the feed cover 2. This prevents undesired moisture from making contact with the feed. In one embodiment, the camera 17 can be used in conjunction with the sensor 16 to determine when to close the feed cover 2 due to inclement weather.

In some embodiments the sensor 16 is used to determine hopper volume. This can instruct the operator when the hopper has become empty, or close to empty. Rather than the user needing to manually inspect the hopper to determine if additional feed is necessary, the sensor 16 can relay such information to the operator. The sensor 16 can be in communication with the controller 18 as described.

In one embodiment, the camera can also detect weather. Thus, even if the sensor 16 has not detected moisture, the camera can determine that it is raining, as an example. The controller 18 can utilize this information in determining whether to open or close the feed cover 2.

The system and method described herein has many benefits. First, the system can automatically close with inclement weather. Inclement weather allows moisture to make contact with the feed. If wet feed sits for a prolonged time, the feed can mold, ruin, etc. Being able to automatically close the feed cover 2 in response to inclement weather reduces the likelihood that feed will become ruined due to moisture.

Second, the system allows the feeder to automatically open or closed based on the determined animal species. This ensures that the desired species, such as deer, elk, etc., is fed, while simultaneously preventing undesired species from having access to the feed.

Preventing unwanted and unintended species from accessing the feed helps conserve feed. The feed is preserved for the intended species. Aside from preventing unintended species from eating the feed, an automatically operational feed cover 2 also prevents access. A racoon or rat, for example, might not only eat the feed, but also defecate in the feed or introduce germs, disease, etc. into the feeder. Thus, preventing unwanted species from accessing the feeder not only prevents undesirable feed waste, but it also prevents feed being spoiled, wasted, or contaminated due to access from undesirable and unintended species.

Third, in some embodiments, the sensor 16 provides the user with the fill volume of the hopper. Thus, if the hopper is close to being empty, the operator will know this information without having to physically inspect the hopper. If the hopper is at 50% capacity, or 75% capacity, the user will know.

The camera 17, sensor 16, and controller 18 can comprise virtually any equipment that operates as described. These components can be electrically coupled to the grid, can operate from batteries, solar power, etc. As noted, these can be in wireless communication with other devices for remote access, or remote control.

While the invention has been particularly shown and described with reference to a preferred embodiment, it will be understood by those skilled in the art that various changes in form and detail may be made therein without departing from the spirit and scope of the invention.

What is claimed is:

1. A controllable hopper comprising:
a hopper housing;
a controllable feed cover moveable relative to a trough;
wherein said feed cover moves from an open position whereby feed is accessible to a closed position whereby feed is inaccessible;
wherein said feed cover is in communication with a controller;
wherein said controller is in communication with a camera.

2. The controllable hopper of claim 1 comprising a gravity feeder.

3. The controllable hopper of claim 1 comprising a spinner feeder.

4. The controllable hopper of claim 1 wherein said feed cover is coupled to actuators to move said feed cover.

5. The controllable hopper of claim 1 wherein said feed cover comprises wheels.

6. The controllable hopper comprising an open feed trough, and wherein said feed cover moves laterally relative to said open feed trough.

7. The controllable hopper further comprising a sensor.

8. The controllable hopper of claim 7 wherein said sensor determines capacity of said hopper housing.

9. The controllable hopper of claim 7 wherein said sensor senses moisture.

10. The controllable hopper of claim 7 wherein said sensor is in communication with said controller.

11. The controllable hopper of claim 1 wherein said camera comprises a species identifying camera.

12. The controllable hopper of claim 11 wherein said species identifying camera utilizes remote software to identify species.

13. The controllable hopper of claim 11 wherein when said species identifying camera identifies an unintended species, the feed cover closes.

14. The controllable hopper of claim 11 wherein when said species identifying camera identifies an intended species, the feed cover opens.

15. The controllable hopper of claim 7 wherein said controller uses information from a timer, said camera, and said sensor in determining whether said feed cover should be open or closed.

16. The controllable hopper of claim 1 wherein said feed cover moves laterally relative to said feed trough.

17. The controllable hopper of claim 1 wherein said feed cover moves angularly relative to said feed trough.
